(19) United States
(12) Patent Application Publication
(10) Pub. No.: US 2026/0169976 A1
(43) Pub. Date: Jun. 18, 2026

(54) CONTROLLED TRANSMISSION OF MULTI-VOLUME CONSISTENCY GROUPS

(71) Applicant: INTERNATIONAL BUSINESS MACHINES CORPORATION, ARMONK, NY (US)

(72) Inventors: YOU HANG WANG, SHANGHAI (CN); ZHI YONG XUE, SHANGHAI (CN); DAN DAN WANG, SHANGHAI (CN); YA JIE LI, BEIJING (CN); BENAMAR MEKHISSI, CARY, NC (US); QI SU, SHANGHAI (CN)

(21) Appl. No.: 18/978,459

(22) Filed: Dec. 12, 2024

(51) Int. Cl. G06F 16/23; G06F 16/27

(52) U.S. Cl. CPC G06F 16/2365; G06F 16/27

(57) ABSTRACT

A method according to an example includes identifying a plurality of volumes of an application to be included in a consistency group, wherein the application is executing on a primary cluster. The method includes replicating the plurality of volumes within the consistency group to a secondary cluster to provide consistency across replicated volumes at the secondary cluster. The method includes updating, at the primary cluster during the replicating, an individual state of each of the plurality of volumes and an overall state of the consistency group.

### BACKGROUND

The present disclosure relates to methods, apparatus, and products for controlled transmission of multi-volume consistency groups.

### SUMMARY

According to embodiments of the present disclosure, various methods, apparatus and products for controlled transmission of multi-volume consistency groups are described herein. In some aspects, controlled transmission of multi-volume consistency groups includes identifying a plurality of volumes of an application to be included in a consistency group, wherein the application is executing on a primary cluster. Controlled transmission of multi-volume consistency groups further includes replicating the plurality of volumes within the consistency group to a secondary cluster to provide consistency across replicated volumes at the secondary cluster. Controlled transmission of multi-volume consistency groups further includes updating, at the primary cluster during the replicating, an individual state of each of the plurality of volumes and an overall state of the consistency group.

### BRIEF DESCRIPTION OF THE DRAWINGS

FIG. 1 sets forth an example computing environment according to aspects of the present disclosure.

FIG. 2 sets forth a container network environment according to aspects of the present disclosure.

FIG. 3 sets forth a method of controlled transmission of multi-volume consistency groups according to aspects of the present disclosure.

### DETAILED DESCRIPTION

Some examples disclosed herein relate generally to network backup systems, and more particularly to systems and methods of backup and disaster recovery for computing resources available via the cloud. Some examples may use snapshot-based asynchronous disaster recovery. Snapshot-based asynchronous disaster recovery architectures may include a primary site and a secondary site. Site replication seeks to provide a copy of a site in a new hosting environment to reduce issues resulting from unavailability of the original site. An initial snapshot may be taken at the primary site and passed to the secondary site, after which incremental snapshots of the primary site may be transferred to the secondary site. The primary site may function as a read-writeable fileset that is able to host applications that are given read/write access to the data stored therein. The data stored in the primary site may be asynchronously replicated to the secondary site. A recovery point objective (RPO) setting may allow for the frequency at which the incremental snapshots are taken to be specified.

Some examples disclosed herein may include container orchestration aspects. Container orchestration technologies have enabled systems to implement containerized software for distributed services, microservices, and/or applications executing or residing in cloud environments. The deployment and scaling of these services, microservices, and/or applications may be accomplished by containers configured to virtualize operating system functionality, in which containers within a network are managed on a container orchestration platform. The containers may be controlled over a plurality of clusters which serve as an accumulation of computing resources for the platform to operate workloads. The containers may be configured to store data by utilizing storage systems allowing multiple sites to replicate and host data associated with the containers. For example, data from a primary site including the containers can be replicated to a secondary site despite the sites being in distinct geographic locations.

In containerized environments, applications may use multiple data volumes for different types of data, such as separate volumes for transaction logs, user data, and configuration files. For example, in a database cluster, different volumes may store database tables, indexes, and transaction logs. A web application may use different volumes for static content, user uploads, and cache data. These volumes need to maintain consistency to ensure data integrity. Consistency across these volumes helps to ensure that the data remains accurate and reliable after recovery from a failure. When performing disaster recovery protection for such applications, the consistent data from these volumes may be periodically transferred to a disaster recovery cluster. A consistency group is a logical grouping of storage volumes that when a snapshot is taken thereof, the snapshot of each of the volumes is at the same point-in-time. The use of a consistency group helps to ensure that a set of volumes is replicated consistently and together so that their state remains synchronized across clusters. Snapshots are a way to protect data within a storage system. A snapshot of the consistency group is generally the state of the consistency group at a particular point in time. In some examples, a snapshot of a consistency group may be a set of pointers, or a set of pointers and associated meta-data, to denote the data stored within the volumes of the consistency group.

Once all the consistent data is transferred, the receiving end may take a snapshot of the consistent data for future recovery in the event of a disaster. However, when the receiving end takes the snapshot, the sending end may need to send an additional control signal to the receiving end to indicate that the transfer of the consistency group has been fully completed. The receiving end may also send an additional control signal to the sending end to notify the sending end that the next cycle of the replication process may be started. This method has certain challenges: (1) it introduces the need for an additional communication channel, increasing complexity and requiring security controls; and (2) alternatively, considering that existing tools already provide a complete data transfer link, it may involve intrusive modifications to the existing data transfer process to send control messages in addition to the data.

In some examples of the present disclosure, a primary cluster maintains, for each data volume in a consistency group to be transmitted, three states for the data transfer: (1) Not Start, (2) Send Data, and (3) Completed. In some examples, a secondary cluster maintains, for each data volume in a consistency group to be received, three states for the data transfer: (1) Not Start, (2) Receive Data, and (3) Completed. In some examples, the primary cluster and the secondary cluster also separately maintain, for the overall consistency group being transferred, three states for the data transfer: (1) Not Started, (2) In Progress, and (3) Blocked. In some examples, the Not Started state for the consistency group indicates that all data volumes in the consistency group are in the Not Start State. In some examples, the In Progress state for the consistency group indicates that at least one data volume in the consistency group is in the Send Data/Receive Data state. In some examples, the Blocked state for the consistency group indicates that all data volumes are in the Completed state.

Some examples disclosed herein help to ensure that actual replication results match expected replication results. For example, if a consistency group includes three volumes (e.g., V1, V2, and V3), a first consistency group snapshot at a first point in time will include all three volumes V1, V2, and V3 of the consistency group at the first point in time. Similarly, a second consistency group snapshot at a second point in time will include all three volumes V1, V2, and V3 of the consistency group at the second point in time, and a third consistency group snapshot at a third point in time will include all three volumes V1, V2, and V3 of the consistency group at the third point in time. In contrast, other methods may result in the first consistency group snapshot at the first point in time including volumes V1 and V2 at the first point in time, and volume V3 at a different point in time. Similarly, the second consistency group snapshot at the second point in time may include volumes V1 and V2 at the second point in time, and volume V3 at the first point in time. Thus, the consistent group at the first point in time would actually include volumes V1 and V2 from the first consistency group snapshot and volume V3 from the second consistency group snapshot. The third consistency group snapshot at the third point in time may include volumes V1 and V2 at the third point in time, and volume V3 at the second point in time. Thus, the consistent group at the second point in time would actually include volumes V1 and V2 from the second consistency group snapshot and volume V3 from the third consistency group snapshot.

Some examples disclosed herein are directed to self-aligned consistency groups and multi-stage controlling in multi-batch data transmission. Some examples manage consistency and reliability of data transmission across multiple persistent volume claims (PVCs) in a container orchestration system. Some examples provide a self-aligned consistency group for transmission of multiple data volumes. Some examples provide for automatic synchronizing/aligning of PVCs for simultaneously updating data across different volumes. Some examples provide a control method for volume batching that establishes a structured framework for grouping and processing PVC operations in batches, allowing for improved efficiency, consistency, and performance during data transmission. In some examples of the present disclosure, no extra communication channel is needed for multi-volume data transmission. Some examples of the present disclosure help to ensure data consistency across volume batching. Some examples provide improved efficiency in disaster recovery for data resilience in a container environment. Some examples disclosed herein significantly improve the efficiency at which storage environments implementing snapshot based data replication are able to operate.

An example of the present disclosure is directed to a method, which includes identifying a plurality of volumes of an application to be included in a consistency group, where the application is executing on a primary cluster. The method includes replicating the plurality of volumes within the consistency group to a secondary cluster to provide consistency across replicated volumes at the secondary cluster. The method includes updating, at the primary cluster during the replicating, an individual state of each of the plurality of volumes and an overall state of the consistency group. The consistency across replicated volumes helps to ensure that if a failover happens, the application can switch to the secondary cluster without any data inconsistency across the volumes.

In some examples of the method, the primary cluster and the secondary cluster are implemented in a cloud environment, and the cloud environment is operated by a container orchestration platform.

In some examples of the method, each of the plurality of volumes respectively begins in a first individual state indicating that individual volume data transmission has not yet started, and the method further includes: updating, for each of the plurality of volumes that have begun having data transmitted to the secondary cluster, the first individual state to a second individual state indicating that individual volume data transmission has started; and updating, for each of the plurality of volumes that have completed having data transmitted to the secondary cluster, the second individual state to a third individual state indicating that individual volume data transmission has completed.

In some examples of the method, the consistency group begins in a first overall state indicating that consistency group data transmission has not yet started, and the method further includes: updating, in response to at least one of the plurality of volumes beginning to have data transmitted to the secondary cluster, the first overall state to a second overall state indicating that consistency group data transmission has started; and updating, in response to all of the plurality of volumes completing having data transmitted to the secondary cluster, the second overall state to a third overall state indicating that consistency group data transmission has completed.

Some examples of the method further include updating, at the secondary cluster during the replicating, an individual state of each of a plurality of replicated volumes and an overall state of a replicated consistency group. In some examples, each of the plurality of replicated volumes respectively begins in a first individual state indicating that individual volume data receipt has not yet started, and the method further includes: updating, for each of the plurality of replicated volumes that have begun receiving data from the primary cluster, the first individual state to a second individual state indicating that individual volume data receipt has started; and updating, for each of the plurality of replicated volumes that have completed receiving data from the primary cluster, the second individual state to a third individual state indicating that individual volume data receipt has completed. In some examples, the replicated consistency group begins in a first overall state indicating that consistency group data receipt has not yet started, and the method further includes: updating, in response to at least one of the plurality of replicated volumes beginning to receive data from the primary cluster, the first overall state to a second overall state indicating that consistency group data receipt has started; and updating, in response to all of the plurality of replicated volumes completing receiving data from the primary cluster, the second overall state to a third overall state indicating that consistency group data receipt has completed.

In some examples of the method, replicating the plurality of volumes within the consistency group further includes: stopping, in response to a threshold period of time passing, writing operations to the plurality of volumes; capturing, during stopping of the writing operations, a consistency group snapshot including a plurality of volume snapshots respectively corresponding to the plurality of volumes; generating a plurality of read-only volumes based on the consistency group snapshot; and transmitting data from the plurality of read-only volumes from the primary cluster to the secondary cluster.

In some examples of the method, the primary cluster and the secondary cluster are geographically separated from each other and are configured to communicate with each other using a wide area network.

Another example of the present disclosure is directed to a computer system, which includes a processor set, and one or more computer-readable storage media. The computer system includes program instructions stored on the one or more storage media to cause the processor set to perform operations including: identifying a plurality of volumes of an application to be included in a consistency group, where the application is executing on a primary cluster. The operations further include replicating the plurality of volumes within the consistency group to a secondary cluster to provide consistency across replicated volumes at the secondary cluster. The operations further include updating, at the primary cluster during the replicating, an individual state of each of the plurality of volumes and an overall state of the consistency group.

In some examples of the computer system, the primary cluster and the secondary cluster are implemented in a cloud environment, and the cloud environment is operated by a container orchestration platform.

In some examples of the computer system, each of the plurality of volumes respectively begins in a first individual state indicating that individual volume data transmission has not yet started, and the operations further include: updating, for each of the plurality of volumes that have begun having data transmitted to the secondary cluster, the first individual state to a second individual state indicating that individual volume data transmission has started; and updating, for each of the plurality of volumes that have completed having data transmitted to the secondary cluster, the second individual state to a third individual state indicating that individual volume data transmission has completed.

In some examples of the computer system, the consistency group begins in a first overall state indicating that consistency group data transmission has not yet started, and the operations further include: updating, in response to at least one of the plurality of volumes beginning to have data transmitted to the secondary cluster, the first overall state to a second overall state indicating that consistency group data transmission has started; and updating, in response to all of the plurality of volumes completing having data transmitted to the secondary cluster, the second overall state to a third overall state indicating that consistency group data transmission has completed.

In some examples of the computer system the operations further include updating, at the secondary cluster during the replicating, an individual state of each of a plurality of replicated volumes and an overall state of a replicated consistency group. In some examples, each of the plurality of replicated volumes respectively begins in a first individual state indicating that individual volume data receipt has not yet started, and the operations further include: updating, for each of the plurality of replicated volumes that have begun receiving data from the primary cluster, the first individual state to a second individual state indicating that individual volume data receipt has started; and updating, for each of the plurality of replicated volumes that have completed receiving data from the primary cluster, the second individual state to a third individual state indicating that individual volume data receipt has completed. In some examples, the replicated consistency group begins in a first overall state indicating that consistency group data receipt has not yet started, and the operations further include: updating, in response to at least one of the plurality of replicated volumes beginning to receive data from the primary cluster, the first overall state to a second overall state indicating that consistency group data receipt has started; and updating, in response to all of the plurality of replicated volumes completing receiving data from the primary cluster, the second overall state to a third overall state indicating that consistency group data receipt has completed.

Another example of the present disclosure is directed to a computer program product, which includes one or more computer-readable storage media. The computer program product includes program instructions stored on the one or more storage media to perform operations that include identifying a plurality of volumes of an application to be included in a consistency group, where the application is executing on a primary cluster. The operations include replicating the plurality of volumes within the consistency group to a secondary cluster to provide consistency across replicated volumes at the secondary cluster. The operations include updating, at the primary cluster during the replicating, an individual state of each of the plurality of volumes and an overall state of the consistency group.

In some examples of the computer program product, the primary cluster and the secondary cluster are implemented in a cloud environment, and the cloud environment is operated by a container orchestration platform.

In some examples of the computer program product, each of the plurality of volumes respectively begins in a first individual state indicating that individual volume data transmission has not yet started, and the operations further include: updating, for each of the plurality of volumes that have begun having data transmitted to the secondary cluster, the first individual state to a second individual state indicating that individual volume data transmission has started; and updating, for each of the plurality of volumes that have completed having data transmitted to the secondary cluster, the second individual state to a third individual state indicating that individual volume data transmission has completed.

In some examples of the computer program product, the consistency group begins in a first overall state indicating that consistency group data transmission has not yet started, and the operations further include: updating, in response to at least one of the plurality of volumes beginning to have data transmitted to the secondary cluster, the first overall state to a second overall state indicating that consistency group data transmission has started; and updating, in response to all of the plurality of volumes completing having data transmitted to the secondary cluster, the second overall state to a third overall state indicating that consistency group data transmission has completed.

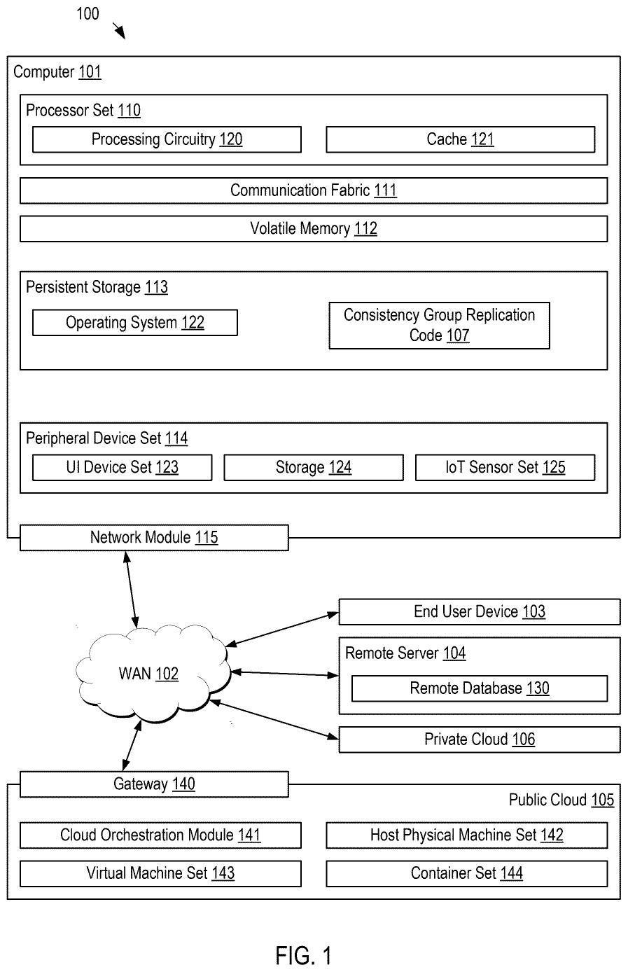

FIG. 1 sets forth an example computing environment 100 according to aspects of the present disclosure. Computing environment 100 contains an example of an environment for the execution of at least some of the computer code involved in performing the various methods described herein, such as consistency group replication code 107. In addition to consistency group replication code 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and consistency group replication code 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in consistency group replication code 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in consistency group replication code 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

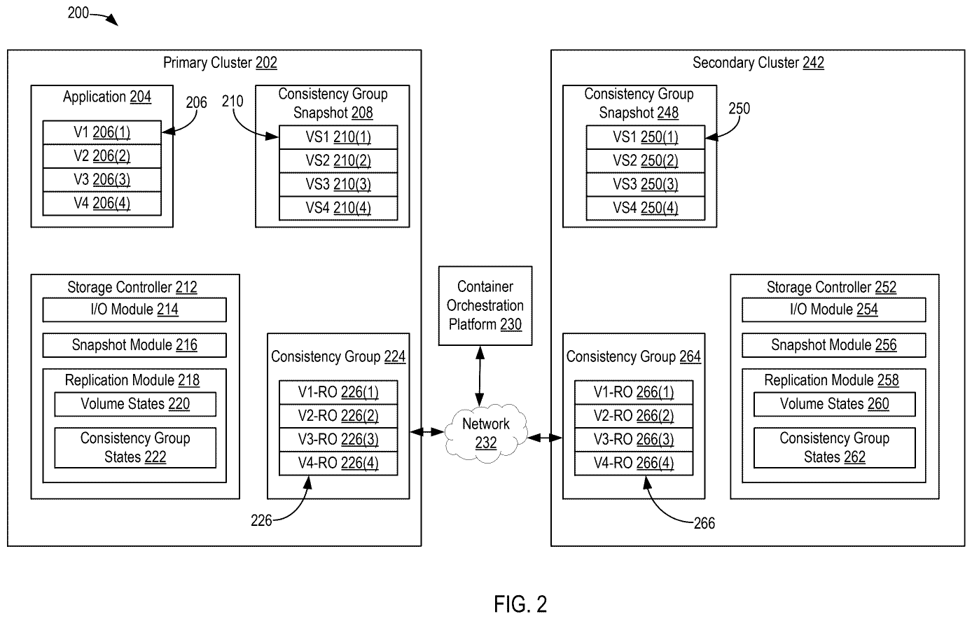

FIG. 2 sets forth a container network environment 200 according to aspects of the present disclosure. The container network environment 200 includes a container orchestration platform (COP) 230, and a distributed data storage system that includes a primary cluster 202 and a secondary cluster 242. In some examples, primary cluster 202 and secondary cluster 242 each include one or more servers, and are communicatively coupled to each other and to COP 230 via network 232. In some examples, either or both of primary cluster 202 and secondary cluster 242 may be implemented with computing environment 100 (FIG. 1), including using consistency group replication code 107 to perform functions described herein.

In some examples, COP 230 includes Kubernetes® (registered trademark of the Linux Foundation) or any other applicable container orchestration system for automating software deployment, scaling, and management. In some examples, COP 230 manages pods which are configured to be applied to management of computing-intensive large scale task applications. For example, pods may function as groups of containers that share network 232 along with computing resources of environment 200 for the purpose of hosting one or more application instances. Services, microservices, and/or applications are configured to run in the pods.

The network 232 connecting the primary cluster 202 and the secondary cluster 242 may be a wide area network (WAN) in some examples. In other examples, the network 232 may include any desired type of network, such as a local area network (LAN), a storage area network (SAN), a personal area network (PAN), etc., depending on the approach. For instance, the type of network 232 used to connect the primary cluster 202 and the secondary cluster 242 may depend on the distance separating these two clusters. According to some approaches, the primary cluster 202 and the secondary cluster 242 may be geographically separated by any amount of physical distance. The network 232 may be a physical network and/or a virtual network. A physical network can be, for example, a physical telecommunications network connecting numerous computing nodes or systems such as computer servers and computer clients. A virtual network can, for example, combine numerous physical networks or parts thereof into a logical virtual network. In another example, numerous virtual networks can be defined over a single physical network. In some embodiments, network 232 is configured as a public cloud computing environment.

In some examples, environment 200 uses snapshot-based asynchronous disaster recovery techniques. Snapshot-based asynchronous disaster recovery architectures may include a source location, which may be the primary cluster 202 in some examples (e.g., under normal operation prior to a disaster recovery situation), and a target location, which may be the secondary cluster 242 in these examples. Snapshots may be incrementally taken at the primary cluster 202 and then passed (e.g., asynchronously replicated) to the secondary cluster 242 for redundant storage. A snapshot may be a set of reference markers for data at a particular point in time. A snapshot may serve as a detailed table of contents, providing accessible copies of data which may be accessed as desired. In other examples (e.g., following a disaster recovery situation), the secondary cluster 242 may function as the source location, while the primary cluster 202 may function as the target location.

An example method to safely back up live data is to temporarily disable write access to data during the backup procedure, either by stopping any accessing applications, or by using a locking application programming interface (API) provided by the operating system to enforce exclusive read access. While the write access is disabled, a snapshot may be taken which represents a read-only copy of the data set as it existed at a given point in time. Snapshots may be triggered based on a timing schedule (e.g., once every five minutes). The primary cluster 202 may function as a read-writeable fileset that is able to host applications that are given read/write access to the data stored therein. The data stored at the primary cluster 202 may be asynchronously replicated to the secondary cluster 242. The secondary cluster 242 may operate as a standby cluster so that if a failure occurs that prevents users from using the application 204, for example, on the primary cluster 202, the application 204 may be started on the secondary cluster 242, and the users may then be routed to the secondary cluster 242.

In some examples, the primary cluster 202 and the secondary cluster 242 may include various types of computer systems, including a desktop computer, a laptop computer, a tablet computer, a mobile phone, a mainframe computer, a server, or other type of computer system. Primary cluster 202 includes storage controller 212. Secondary cluster 242 includes storage controller 252. The storage controllers 212 and 252 may be able to communicate with each other (e.g., send data, commands, requests, etc. to each other) using a connection to network 232. The storage controller 212 includes input/output (I/O) module 214, snapshot module 216, and replication module 218. The storage controller 252 includes input/output (I/O) module 254, snapshot module 256, and replication module 258. In some examples, I/O modules 214 and 254 conduct block I/O. During a write operation, for example, I/O module 214 may receive one or more blocks and associated one or more logical block addresses (LBA) from an operating system and/or application 204, and may write the one or more blocks to one or more volumes within primary cluster 202.

The volume in which the data that is initially stored within the storage device as a result of a write request may be referred to as an original volume. The original volume may be logically within a single device. Alternatively, the original volume may be located across multiple devices. As shown in FIG. 2, application 204 includes associated original volumes 206(1)-206(4) (collectively referred to as volumes 206). The original volumes 206 include four different original volumes (V1-V4) in the illustrated example, although other examples may use more or less than four original volumes for any given application. In some examples, the original volumes 206 are persistent volumes (PVs) or persistent volume claims (PVCs).

Snapshot module 216 controls taking snapshots of data within original volumes 206 in primary cluster 202. In some examples, snapshot module 216 controls and takes consistent point-in-time snapshots of original volumes 206. FIG. 2 illustrates a point-in-time consistency group snapshot 208 of a consistency group that includes four original volumes 206. A consistency group is a logical grouping of original volumes 206. When a snapshot 208 is taken of the consistency group, the snapshot 208 includes a snapshot of each of the original volumes 206 taken at the same point-in-time. As shown in FIG. 2, snapshot 208 includes volume snapshots 210(1)-210(4) (collectively referred to as volume snapshots 210), which respectively correspond to original volumes 206(1)-206(4). The volume snapshots 210 include four different volume snapshots (VS1-VS4) in the illustrated example, although other examples may use more or less than four original volumes and four corresponding volume snapshots. Snapshot 208 of the consistency group is a data structure that generally describes the state of the consistency group at a particular point in time. In some examples, snapshot 208 may be a set of pointers, or a set of pointers and associated meta-data, to denote the data stored within the volumes 206 of the consistency group.

Snapshot module 216 may take a consistency group snapshot 208 at different points-in-time, such as at a regular interval. In some examples, each time a new consistency group snapshot 208 is generated, replication module 218 generates a corresponding consistency group 224 that includes a plurality of read-only (RO) volumes 226(1)-226(4) (collectively referred to as read-only volumes 226). The plurality of read-only volumes 226(1)-226(4) are generated based on the volume snapshots 210(1)-210(4), respectively. The read-only volumes 226 include four different read-only volumes (V1-RO, V2-RO, V3-RO, and V4-RO) respectively corresponding to the volume snapshots 210(1)-210(4).

Replication module 218 replicates the consistency group 224 at the secondary cluster 242 to provide a replicated consistency group 264 with a plurality of replicated read-only volumes 266(1)-266(4) (collectively referred to as replicated volumes 266). The replicated read-only volumes 266 include four different replicated read-only volumes (V1-RO, V2-RO, V3-RO, and V4-RO) respectively corresponding to the read-only volumes 226(1)-226(4). In some examples, a replication process is periodically triggered based on a timing schedule, and each time the replication process is triggered, snapshot module 216 takes a consistency group snapshot 208, replication module 218 generates a corresponding consistency group 224, and replication module 218 replicates the consistency group 224 at the secondary cluster 242. In some examples, the replication process includes stopping, in response to a threshold period of time passing, writing operations to the plurality of original volumes 206; capturing, during stopping of the writing operations, a consistency group snapshot 208 including a plurality of volume snapshots 210 respectively corresponding to the plurality of original volumes 206; generating a plurality of read-only volumes 226 based on the consistency group snapshot 208; and transmitting data from the plurality of read-only volumes 226 from the primary cluster 202 to the secondary cluster 242.

In some examples, replication module 218 maintains volume states 220, which indicate a current individual state of each of the read-only volumes 226. In some examples, at any given point in time, each of the read-only volumes 226 is in one of three different states: (1) a first volume state (e.g., Not Start) indicating that individual volume data transmission for that volume has not yet started; (2) a second volume state (e.g., Send Data) indicating that individual volume data transmission has started for that volume; and (3) a third volume state (e.g., Completed) indicating that individual volume data transmission for that volume has completed.

In some examples, replication module 218 also maintains consistency group states 222, which indicate a current overall state of the consistency group 224. In some examples, at any given point in time, the consistency group 224 is in one of three different states: (1) a first consistency group state (e.g., Not Start) indicating that consistency group data transmission has not yet started; (2) a second consistency group state (e.g., In Progress) indicating that consistency group data transmission has started (e.g., individual volume data transmission for at least one of the read-only volumes 226 has started); and (3) a third consistency group state (e.g., Blocked) indicating that consistency group data transmission has completed (e.g., individual volume data transmission for all of the read-only volumes 226 in the consistency group 224 has completed).

Replication module 218 updates the volume states 220 and the consistency group states 222 during the replication process. In some examples, each of the plurality of read-only volumes 226 respectively begins in a first individual state (e.g., the Not Start volume state) indicating that individual volume data transmission for that volume has not yet started. For each of the plurality of read-only volumes 226 that have begun having data transmitted to the secondary cluster 242, the replication module 218 updates the first individual state for those individual volumes to a second individual state (e.g., the Send Data volume state) indicating that individual volume data transmission has started. For each of the plurality of read-only volumes 226 that have completed having data transmitted to the secondary cluster 242, the replication module 218 updates the second individual state to a third individual state (e.g., the Completed volume state) indicating for those individual volumes that individual volume data transmission has completed.

In some examples, the consistency group 224 begins in a first overall state (e.g., the Not Start consistency group state) indicating that consistency group data transmission has not yet started. In some examples, in response to at least one of the plurality of read-only volumes 226 beginning to have data transmitted to the secondary cluster 242, the replication module 218 updates the first overall state to a second overall state (e.g., the In Progress consistency group state) indicating that consistency group data transmission has started. In some examples, in response to all of the plurality of read-only volumes 226 completing having data transmitted to the secondary cluster 242, the replication module 218 updates the second overall state to a third overall state (e.g., the Blocked consistency group state) indicating that consistency group data transmission has completed.

In some examples, the replication module 258 in the secondary cluster 242 maintains volume states 260, which indicate a current individual state of each of the replicated read-only volumes 266. In some examples, at any given point in time, each of the replicated read-only volumes 266 is in one of three different states: (1) a first volume state (e.g., Not Start) indicating that individual volume data receiving for that volume has not yet started; (2) a second volume state (e.g., Receive Data) indicating that individual volume data receiving has started for that volume; and (3) a third volume state (e.g., Completed) indicating that individual volume data receiving for that volume has completed.

In some examples, the replication module 258 in the secondary cluster 242 also maintains consistency group states 262, which indicate a current overall state of the replicated consistency group 264. In some examples, at any given time, the replicated consistency group 264 is in one of three different states: (1) a first consistency group state (e.g., Not Start) indicating that consistency group data receiving has not yet started; (2) a second consistency group state (e.g., In Progress) indicating that consistency group data receiving has started (e.g., individual volume data receiving for at least one of the read-only volumes 266 has started); and (3) a third consistency group state (e.g., Blocked) indicating that consistency group data receiving has completed (e.g., individual volume data receiving for all of the replicated read-only volumes 266 in the replicated consistency group 264 has completed).

Replication module 258 updates the volume states 260 and the consistency group states 262 during the replication process. In some examples, each of the plurality of replicated read-only volumes 266 respectively begins in a first individual state (e.g., the Non Start volume state) indicating that individual volume data receipt for that volume has not yet started. For each of the plurality of replicated read-only volumes 266 that have begun receiving data from the primary cluster 202, the replication module 258 updates the first individual state to a second individual state (e.g., the Receive Data volume state) indicating that individual volume data receipt has started. For each of the plurality of replicated read-only volumes 266 that have completed receiving data from the primary cluster 202, the replication module 258 updates the second individual state to a third individual state (e.g., the Completed volume state) indicating that individual volume data receipt has completed.

In some examples, the replicated consistency group 264 begins in a first overall state (e.g., the Not Start consistency group state) indicating that consistency group data receipt has not yet started. In some examples, in response to at least one of the plurality of replicated read-only volumes 266 beginning to receive data from the primary cluster 202, the replication module 258 updates the first overall state to a second overall state (e.g., the In Progress consistency group state) indicating that consistency group data receipt has started. In some examples, in response to all of the plurality of replicated read-only volumes 266 completing receiving data from the primary cluster 202, the replication module 258 updates the second overall state to a third overall state (e.g., the Blocked consistency group state) indicating that consistency group data receipt has completed.

In some examples, once the second overall state is updated to the third overall state (e.g., the Blocked consistency group state) indicating that consistency group data receipt by the secondary cluster 242 has completed, snapshot module 256 may capture a point-in-time consistency group snapshot 248 of the replicated consistency group 264. Consistency group snapshot 248 includes volume snapshots 250(1)-250(4) (collectively referred to as volume snapshots 250), which respectively correspond to replicated read-only volumes 266(1)-266(4). The volume snapshots 250 include four different volume snapshots (VS1-VS4) in the illustrated example. The consistency group snapshot 248 may be used for failover or relocation of the application 204.

In some examples, after the second overall state is updated to the third overall state (e.g., the Blocked consistency group state) indicating that consistency group data receipt by the secondary cluster 242 has completed, the volume states 220 and 260 may remain in the third volume state (e.g., Completed) until a next periodic cycle of the replication process, and may be switched to the second volume state (e.g., Send Data/Receive Data) when data transfer for that cycle begins. Similarly, the consistency group states 222 and 262 may remain in the third consistency group state (e.g., Blocked) until the next periodic cycle of the replication process, and may be switched to the second consistency group state (e.g., In Progress) when data transfer for that cycle begins.

In some examples, rather than replicating complete volumes during each cycle of the replication process, only the differences or the delta between the data in the current volumes at the primary cluster 202 and the data in the volumes previously transmitted to the secondary cluster 242 are transmitted to the secondary cluster during each cycle of the replication process. The data in the consistency group 224 may be transmitted to the secondary cluster 242 one volume at a time (e.g., sequentially), or may be transmitted for multiple or all volumes concurrently. The volumes may be transmitted sequentially in any order without losing consistency because the data in the volumes was captured in a consistent manner with the consistency group snapshot 208. In some examples, the replicated consistency group 264 is deemed to be complete with consistent data when all of the data from the consistency group 224 has been transferred to the secondary cluster 242 (as indicated by the volume states 220 and 260 and the consistency group states 222 and 262). If an issue arises and some of the data from the consistency group 224 is not transferred to the secondary cluster 242 within the current cycle of the replication process, the replicated consistency group 264 may be deemed to be incomplete with data that is not consistent.

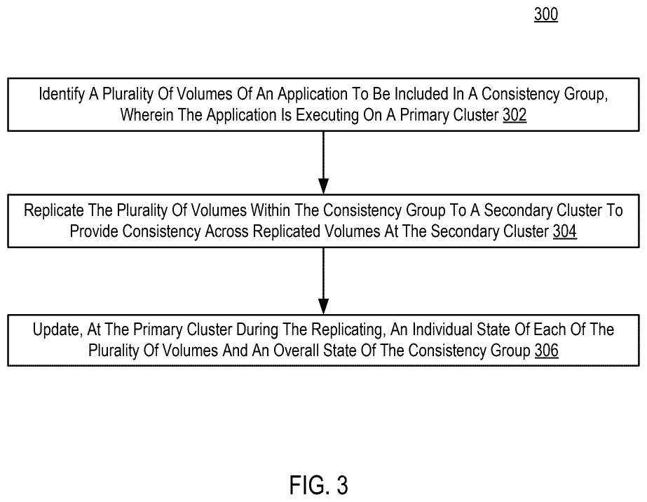

FIG. 3 sets forth a method 300 of controlled transmission of multi-volume consistency groups according to aspects of the present disclosure. In some examples, computing environment 100 (FIG. 1) and/or container network environment 200 (FIG. 2) are configured to perform method 300 using consistency group replication code 107. Method 300 includes identifying 302 a plurality of volumes of an application to be included in a consistency group, wherein the application is executing on a primary cluster. The method 300 includes replicating 304 the plurality of volumes within the consistency group to a secondary cluster to provide consistency across replicated volumes at the secondary cluster. The method 300 includes updating 306, at the primary cluster during the replicating, an individual state of each of the plurality of volumes and an overall state of the consistency group.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying a plurality of volumes of an application to be included in a consistency group, wherein the application is executing on a primary cluster;
replicating the plurality of volumes within the consistency group to a secondary cluster to provide consistency across replicated volumes at the secondary cluster; and
updating, at the primary cluster during the replicating, an individual state of each of the plurality of volumes and an overall state of the consistency group.

2. The method of claim 1, wherein the primary cluster and the secondary cluster are implemented in a cloud environment, and wherein the cloud environment is operated by a container orchestration platform.

3. The method of claim 1, wherein each of the plurality of volumes respectively begins in a first individual state indicating that individual volume data transmission has not yet started, and wherein the method further comprises:
updating, for each of the plurality of volumes that have begun having data transmitted to the secondary cluster, the first individual state to a second individual state indicating that individual volume data transmission has started; and
updating, for each of the plurality of volumes that have completed having data transmitted to the secondary cluster, the second individual state to a third individual state indicating that individual volume data transmission has completed.

4. The method of claim 1, wherein the consistency group begins in a first overall state indicating that consistency group data transmission has not yet started, and wherein the method further comprises:
updating, in response to at least one of the plurality of volumes beginning to have data transmitted to the secondary cluster, the first overall state to a second overall state indicating that consistency group data transmission has started; and
updating, in response to all of the plurality of volumes completing having data transmitted to the secondary cluster, the second overall state to a third overall state indicating that consistency group data transmission has completed.

5. The method of claim 1, and further comprising:
updating, at the secondary cluster during the replicating, an individual state of each of a plurality of replicated volumes and an overall state of a replicated consistency group.

6. The method of claim 5, wherein each of the plurality of replicated volumes respectively begins in a first individual state indicating that individual volume data receipt has not yet started, and wherein the method further comprises:
updating, for each of the plurality of replicated volumes that have begun receiving data from the primary cluster, the first individual state to a second individual state indicating that individual volume data receipt has started; and
updating, for each of the plurality of replicated volumes that have completed receiving data from the primary cluster, the second individual state to a third individual state indicating that individual volume data receipt has completed.

7. The method of claim 5, wherein the replicated consistency group begins in a first overall state indicating that consistency group data receipt has not yet started, and wherein the method further comprises:
updating, in response to at least one of the plurality of replicated volumes beginning to receive data from the primary cluster, the first overall state to a second overall state indicating that consistency group data receipt has started; and
updating, in response to all of the plurality of replicated volumes completing receiving data from the primary cluster, the second overall state to a third overall state indicating that consistency group data receipt has completed.

8. The method of claim 1, wherein replicating the plurality of volumes within the consistency group further comprises:
stopping, in response to a threshold period of time passing, writing operations to the plurality of volumes;
capturing, during stopping of the writing operations, a consistency group snapshot including a plurality of volume snapshots respectively corresponding to the plurality of volumes;
generating a plurality of read-only volumes based on the consistency group snapshot; and
transmitting data from the plurality of read-only volumes from the primary cluster to the secondary cluster.

9. The method of claim 1, wherein the primary cluster and the secondary cluster are geographically separated from each other and are configured to communicate with each other using a wide area network.

10. A computer system comprising:
a processor set;
one or more computer-readable storage media; and
program instructions stored on the one or more storage media to cause the processor set to perform operations comprising:
identifying a plurality of volumes of an application to be included in a consistency group, wherein the application is executing on a primary cluster;
replicating the plurality of volumes within the consistency group to a secondary cluster to provide consistency across replicated volumes at the secondary cluster; and
updating, at the primary cluster during the replicating, an individual state of each of the plurality of volumes and an overall state of the consistency group.

11. The computer system of claim 10, wherein the primary cluster and the secondary cluster are implemented in a cloud environment, and wherein the cloud environment is operated by a container orchestration platform.

12. The computer system of claim 10, wherein each of the plurality of volumes respectively begins in a first individual state indicating that individual volume data transmission has not yet started, and wherein the operations further comprise:
updating, for each of the plurality of volumes that have begun having data transmitted to the secondary cluster, the first individual state to a second individual state indicating that individual volume data transmission has started; and
updating, for each of the plurality of volumes that have completed having data transmitted to the secondary cluster, the second individual state to a third individual state indicating that individual volume data transmission has completed.

13. The computer system of claim 10, wherein the consistency group begins in a first overall state indicating that consistency group data transmission has not yet started, and wherein the operations further comprise:
updating, in response to at least one of the plurality of volumes beginning to have data transmitted to the secondary cluster, the first overall state to a second overall state indicating that consistency group data transmission has started; and
updating, in response to all of the plurality of volumes completing having data transmitted to the secondary cluster, the second overall state to a third overall state indicating that consistency group data transmission has completed.

14. The computer system of claim 10, wherein the operations further comprise:
updating, at the secondary cluster during the replicating, an individual state of each of a plurality of replicated volumes and an overall state of a replicated consistency group.

15. The computer system of claim 14, wherein each of the plurality of replicated volumes respectively begins in a first individual state indicating that individual volume data receipt has not yet started, and wherein the operations further comprise:
updating, for each of the plurality of replicated volumes that have begun receiving data from the primary cluster, the first individual state to a second individual state indicating that individual volume data receipt has started; and
updating, for each of the plurality of replicated volumes that have completed receiving data from the primary cluster, the second individual state to a third individual state indicating that individual volume data receipt has completed.

16. The computer system of claim 14, wherein the replicated consistency group begins in a first overall state indicating that consistency group data receipt has not yet started, and wherein the operations further comprise:
updating, in response to at least one of the plurality of replicated volumes beginning to receive data from the primary cluster, the first overall state to a second overall state indicating that consistency group data receipt has started; and
updating, in response to all of the plurality of replicated volumes completing receiving data from the primary cluster, the second overall state to a third overall state indicating that consistency group data receipt has completed.

17. A computer program product comprising:
one or more computer-readable storage media; and
program instructions stored on the one or more storage media to perform operations comprising:
identifying a plurality of volumes of an application to be included in a consistency group, wherein the application is executing on a primary cluster;
replicating the plurality of volumes within the consistency group to a secondary cluster to provide consistency across replicated volumes at the secondary cluster; and
updating, at the primary cluster during the replicating, an individual state of each of the plurality of volumes and an overall state of the consistency group.

18. The computer program product of claim 17, wherein the primary cluster and the secondary cluster are implemented in a cloud environment, and wherein the cloud environment is operated by a container orchestration platform.

19. The computer program product of claim 17, wherein each of the plurality of volumes respectively begins in a first individual state indicating that individual volume data transmission has not yet started, and wherein the operations further comprise:
updating, for each of the plurality of volumes that have begun having data transmitted to the secondary cluster, the first individual state to a second individual state indicating that individual volume data transmission has started; and
updating, for each of the plurality of volumes that have completed having data transmitted to the secondary cluster, the second individual state to a third individual state indicating that individual volume data transmission has completed.

20. The computer program product of claim 17, wherein the consistency group begins in a first overall state indicating that consistency group data transmission has not yet started, and wherein the operations further comprise:
updating, in response to at least one of the plurality of volumes beginning to have data transmitted to the secondary cluster, the first overall state to a second overall state indicating that consistency group data transmission has started; and
updating, in response to all of the plurality of volumes completing having data transmitted to the secondary cluster, the second overall state to a third overall state indicating that consistency group data transmission has completed.
